(19) United States
(12) Patent Application Publication
(10) Pub. No.: US 2020/0380879 A1
(43) Pub. Date: Dec. 3, 2020

(54) Color Intonation Display System and Method Thereof

(71) Applicant: Gee Song Moon, Seoul (KR)

(72) Inventor: Gee Song Moon, Seoul (KR)

(21) Appl. No.: 15/774,591

(22) PCT Filed: Nov. 6, 2015
(86) PCT No.: PCT/KR2015/011924

§ 371 Date: Jul. 10, 2020

(51) Int. Cl. G09B 5/02; G09B 19/06

(52) U.S. Cl. CPC G09B 5/02; G09B 19/06

(57) ABSTRACT

The present invention relates to a system for displaying Chinese character intonations, and a method thereof and, more particularly, to a color intonation display system and a method thereof, the system: displaying Chinese character intonations as color intonations of which the Chinese characters colors have been changed, such that a user can visually and easily understand an intonation even without separately marking the intonation at the upper side of Chinese characters or there around again after inputting the Chinese characters; and distinguishing the inputted Chinese characters per word and displaying the same as intonations so as to reduce a ratio required for selecting the intonation in comparison to transforming the intonation of each single Chinese character having several intonations into a color intonation, thereby reducing a color intonation marking time, or to display several intonations of a single-character word in parallel for the single character word, thereby reducing an intonation selection time of the user.

### TECHNICAL FIELD

The present invention relates to a system for displaying Chinese character intonations, and a method thereof and, more particularly, to a color intonation display system and a method thereof, the system: displaying Chinese character intonations as color intonations of which the Chinese characters colors have been changed, such that a user can visually and easily understand an intonation even without separately marking the intonation at the upper side of Chinese characters or there around again after inputting the Chinese characters; and distinguishing the inputted Chinese characters per word and displaying the same as intonations so as to reduce a ratio required for selecting the intonation in comparison to transforming the intonation of each single Chinese character having several intonations into a color intonation, thereby reducing a color intonation marking time, or to display several intonations of a single-character word in parallel for the single character word, thereby reducing an intonation selection time of the user.

### BACKGROUND TECHNOLOGY

Generally, to study the Chinese language, pronunciation and intonation of the Chinese language must be mastered first. The reference for pronunciation of the Chinese language is Chinese phonetic alphabet ( [symbol] ) announced by the national language character craft committee ( [symbol] [symbol] ) of China on December, 1985. The Chinese phonetic alphabet refers to a pronunciation system for Chinese pronunciation of the syllabic ( [symbol] ) consisting of 21 consonants ( [symbol] ) and 16 vowels ( [symbol] ) borrowing alphabet symbols. Chinese intonation ( [symbol] ) is a unique accent of the Chinese language and refers to display of tone of each pronunciation to the vowel, generally, “-” the first intonation, “ [symbol] ” the second intonation, “∨” the third intonation and “\” the fourth intonation.

Therefore, in order to study the Chinese language, in addition to Chinese character and simplified Chinese character, the each different intonation per every Chinese character for Chinese pronunciation must be acquired. Not only it is cumbersome to write the intonation above or around each Chinese character, but also to study by reading the written intonation is difficult thereby giving up studying the Chinese language half-way.

### PATENT LITERATURE

Registered patent publication no. 10-1172580 (published on Aug. 9, 2012) “Method to Display Chinese Pronunciation in Korean”

In the prior art of the above patent literature, a method for expressing Chinese pronunciation with Korean letters by expressing the Chinese language with combination of only Korean consonants and vowels is disclosed for easy to access study for Chinese language for novice learners who cannot approach to the Chinese language study because of strong resistance about Chinese character, simplified Chinese character, alphabet (pronunciation expression system) and intonation (tone) and for those who abandon Chinese study half-way due to difficulty of the Chinese language. It discloses combining Korean letters corresponding to consonants and vowels of Chinese phonetic alphabet, displaying one through three syllables of Korean letters, and displaying the intonation writing in parallel with said one through three syllables of Korean letters. However, since this prior art also eventually writes separate intonation display in addition to pronunciation display in Korean besides a Chinese character, it is cumbersome to input each of them, and the way in which a user acquires by reading the intonation display separately written in parallel is the same as before, and losing interest in studying Chinese and giving up half-way still occur.

### DETAILED DESCRIPTION OF THE INVENTION

### Technical Task

The present invention was made to solve above-mentioned problems.

An object of the invention is to provide a color intonation display system and method that enables a user to understand intonation easily and visually without separately displaying intonation again above or around a Chinese character after inputting a Chinese character by displaying the intonation of the Chinese character as color intonation that changed the color of the Chinese character.

Another object of the invention is to provide a color intonation display system and method that enables a user to associate the color of each Chinese character and to study the intonation easily by expressing the first though fourth intonations, which are intonations of Chinese characters, with different colors.

Still another object of the invention is to provide a color intonation display system and method that can reduce color intonation display time by reducing the ratio of selecting intonation compared to converting into color intonation per one Chinese character that has multiple intonations by displaying color intonation after distinguishing Chinese charter inputs per word.

Still another object of the invention is to provide a color intonation display system and method that can reduce user's intonation selection time by displaying multiple intonations of the single word in parallel in case of a single word.

Still another object of the invention is to provide a color intonation display system and method that can enhance the precision of intonation selection by providing advice about the most appropriate intonation among the multiple intonations displayed in parallel considering correlation with words before or after the word in case of a single word having multiple intonations.

### Means to Perform Tasks

In order to achieve the above objects, the present invention provides a color intonation display system and method having following constructions.

A color intonation display system according to an embodiment of the present invention is characterized in that an intonation of Chinese character that is input to the system is changed to a color intonation and the color intonation is displayed.

According to another embodiment, the system of the present invention is characterized in that said color intonation displays the first through the fourth intonations of Chinese character with different colors.

According to still another embodiment, the system of the present invention is characterized in that the system comprises an input module into which a Chinese character is input, an intonation storage that stores intonation data for Chinese characters, and a color intonation display module that matches intonation of the Chinese character input to said input module with data stored in said intonation storage module and displays as the color intonation.

According to still another embodiment, the system of the present invention is characterized in that said color intonation display module distinguishes the Chinese character input per word and matches it with data stored in the intonation storage and displays the color intonation.

According to still another embodiment, the system of the present invention is characterized in that said color intonation display module comprises an intonation selection module that that enables intonation selection when the Chinese character input is a single word having multiple intonations.

According to still another embodiment, the system of the present invention is characterized in that said color intonation selection module comprises a discerning module that discerns whether the Chinese character input is a single word having multiple intonations, a parallel display module that displays the multiple color intonations of the sing word discerned and matched with data stored in said intonation storage in parallel, and a user selection module in which one of the multiple intonations that are displayed in parallel may be selected by a user.

According to still another embodiment, the system of the present invention is characterized in that said intonation selection module further comprises an advising module that provides advice about the most appropriate intonation among the multiple intonations displayed in parallel considering correlation with words before or after the discerned single word.

According to still another embodiment, the system of the present invention is characterized in that said color intonation expresses the first intonation as black, the second intonation as green, the third intonation as red and the fourth intonation as yellow.

A color intonation display method according to an embodiment of the present invention is characterized in that an intonation of Chinese character that is input to the system is displayed as a color intonation that changed the color of the Chinese character.

According to another embodiment, the method of the present invention is characterized in that the method comprises an input stage in which a Chinese character is input; and a color intonation display stage in which the Chinese character input is matched with intonation data stored in an intonation storage and the color intonation is displayed.

According to still another embodiment, the method of the present invention is characterized in that said color intonation displays the first through the fourth intonations of Chinese character with different colors.

According to still another embodiment, the method of the present invention is characterized in that said color intonation display stage distinguishes the Chinese character input per word and matches it with data stored in the intonation storage and displays the color intonation.

According to still another embodiment, the method of the present invention is characterized in that said color intonation display stage comprises a discerning stage that discerns whether the Chinese character input is a single word having multiple intonations, a parallel display stage that displays the multiple color intonations of the sing word discerned and matched with data stored in said intonation storage in parallel, and a user selection stage in which one of the multiple intonations that are displayed in parallel is selected by a user.

According to still another embodiment, the method of the present invention is characterized in that said color intonation display stage further comprises an advising stage that provides advice about the most appropriate intonation among the multiple intonations displayed in parallel considering correlation with words before or after the discerned single word.

Still another embodiment of the present invention is a computer-readable recording medium characterized in that a program to perform said method is recorded in the medium.

### Effects of the Invention

The present invention has the following effects from the above-explained embodiments and the construction, combination and use relations explained below.

The present invention has an effect that enables a user to understand intonation easily and visually without separately displaying intonation again above or around a Chinese character after inputting a Chinese character by displaying the intonation of the Chinese character as color intonation that changed the color of the Chinese character.

The present invention has an effect that enables a user to associate the color of each Chinese character and to study the intonation easily by expressing the first though fourth intonations, which are intonations of Chinese characters, with different colors.

The present invention has an effect that enables reduction of color intonation display time by reducing the ratio of selecting intonation compared to converting into color intonation per one Chinese character that has multiple intonations by displaying color intonation after distinguishing Chinese charter inputs per word.

The present invention has an effect that enables reduction of user's intonation selection time by displaying multiple intonations of the single word in parallel in case of a single word.

The present invention has an effect that enables enhancing the precision of intonation selection by providing advice about the most appropriate intonation among the multiple intonations displayed in parallel considering correlation with words before or after the word in case of a single word having multiple intonations.

### BRIEF DESCRIPTION OF THE DRAWINGS

FIG. 1 is a reference drawing that illustrates the pronunciation and intonation of Chinese character in general.

FIG. 2 is a reference drawing that illustrates tones of the 4 intonations that are intonations of Chinese characters.

FIG. 3 is a reference drawing that illustrates motif of color intonations according to an embodiment of the present invention.

FIG. 4 is a reference drawing that illustrates the tone per color intonation according to an embodiment of the present invention.

FIG. 5 is a block diagram that illustrates a color intonation display system according to an embodiment of the present invention.

FIG. 6 is a block diagram that illustrates details of an intonation selection module.

FIG. 7 is a reference drawing that illustrates a color intonation display system of the present invention and an example of application of the method in which color intonations are displayed for words.

FIG. 8 is a reference drawing that illustrates a state of studying (applying) intonation by watching Chinese character with color intonation of FIG. 7 applied.

FIG. 9 is a flow diagram for a color intonation display method according to an embodiment of the present invention.

### BEST EMBODIMENT OF THE INVENTION

Preferred embodiments for a color intonation display system and method according to the present invention are explained in detail below with reference to the attached drawings. In explaining the present invention below, in case that it is decided that concrete explanation for known functions or constitutions may unnecessarily make the subject matter of the present invention unclear, such detailed explanation is to be omitted. In the entire specification, when a part “includes” another part, it means that a different part may be included and not that a different part is excluded as far as there is no contrary description. Also, terms including “ . . . portion,” “ . . . module,” etc. in the specification mean a unit that performs at least one function or operation, and it may be implemented by hardware, software or combination thereof.

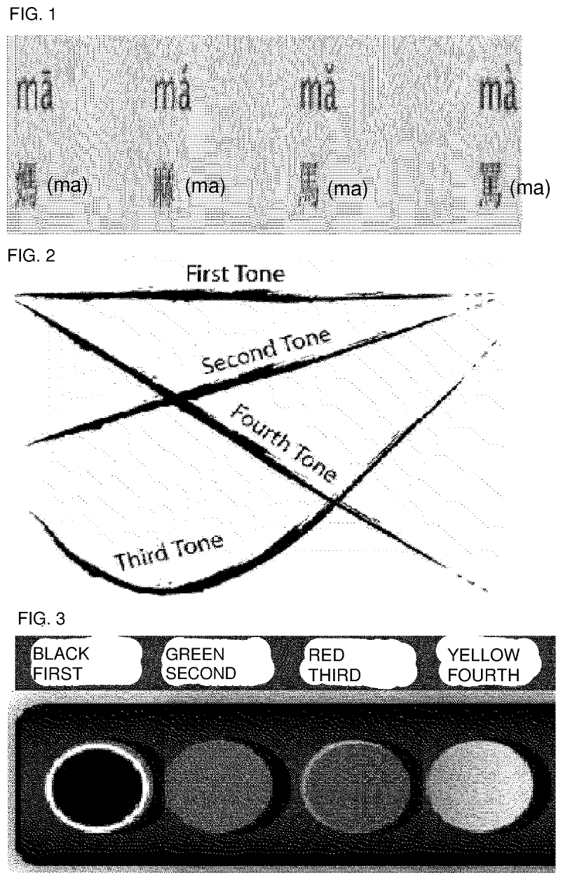

Referring to FIG. 1, Generally, the method to display Chinese character is to write a Chinese character and display Chinese phonetic alphabet, which is a pronunciation system for Chinese pronunciation of the syllabic ( [symbol] ) consisting of 21 consonants ( [symbol] ) and 16 vowels ( [symbol] ) borrowing alphabet symbols, on the upper side of the Chinese character, and to display the intonation, which is the tone of each pronunciation to the vowel. Generally, the tone is displayed at the vowel “-” as the first intonation, “ [symbol] ” as the second intonation, “∨” as the third intonation and “\” as the fourth intonation. However, as shown on FIG. 1, the Chinese language has many cases in which multiple letters having different meaning represent the same pronunciation, and intonation enables discerning in conversation. Therefore, intonation is very important part in studying the Chinese language but acquiring (memorizing) the intonation one by one is very difficult and it frequently happens to giving up studying the Chinese language half-way. In addition, for the intonation display as above, it is cumbersome to write the intonation above or around each Chinese character, and a user suffers severe difficulty in preparing documents.

Accordingly, the basic idea of the present invention to solve these existing problems is not only to fundamentally modify the existing intonation display method, in which even displaying side by side with Chinese character is difficult, but also to apply color in displaying intonation and to display the intonation of a Chinese character by color intonation that changed the color of the Chinese character thereby enabling a student (user) to recognize intonation visually and to memorize and study intonation easily through association process that facilitates for the brain to memorize. That is, by displaying each of the first through the fourth intonation, which are intonations of the Chinese character, with different color on the Chinese character itself, the cumbersomeness and difficulty of the existing display itself that requires displaying Chinese character and intonation separately in preparing documents are solved, and a student (user) studying this visually recognizes the intonation that is displayed in color and through the unique color that is associated with the corresponding Chinese character thereby learning and memorizing the intonation of the corresponding Chinese character easily.

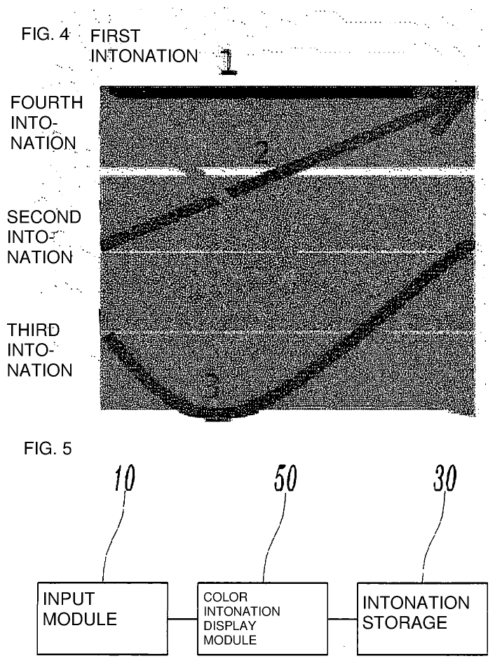

Especially, when colors that are applied to traffic signal, which is world universal standard, are utilized as motif for the colors of the color intonation that is applied to each intonation of Chinese character, it helps studying by easily associating the image of the color for the corresponding color intonation, for people in not only a specific country but also various countries when they study Chinese characters. For example, referring to FIGS. 3 and 4, generally, when green traffic signal is turned on, waiting cars accelerate and increase their speed gradually, which is similar to the tone of the second intonation of Chinese character for which the tone rises gradually, and therefore, if green is applied to the second intonation among the color intonations, a green traffic light and following vehicle acceleration are easily reminded, and a student can easily associate the color intonation and its tone thereby facilitating studying intonation. Also, if yellow lamp is turned on in a traffic light, a moving vehicle reduce its speed gradually, which is similar to the tone of the fourth intonation of Chinese character for which the tone falls gradually, and when yellow is applied to the fourth intonation among the color intonations, a yellow traffic light and following vehicle deceleration are easily reminded, and a student can easily associate the color intonation and its tone thereby facilitating studying intonation. Also, if red lamp is turned on in a traffic light, a moving vehicle stops suddenly and then starts moving again, which is similar to the tone of the third intonation of Chinese character for which the tone falls and then rises, and when red is applied to the third intonation among the color intonations, a red traffic light and following vehicle's sudden stop and staring again easily reminded, and a student can easily associate the color intonation and its tone thereby facilitating studying intonation. Also, if black, which is not included in existing traffic lights and commonly used in documents, means continuous driving (constant speed driving) in a state where no special signal is present, which is similar to the tone of the first intonation of Chinese character for which the tone is kept constant, and when black is applied to the first intonation among the color intonations, a continuous (constant speed) driving under no signal presence state is easily reminded, and a student can easily associate the color intonation and its tone thereby facilitating studying intonation.

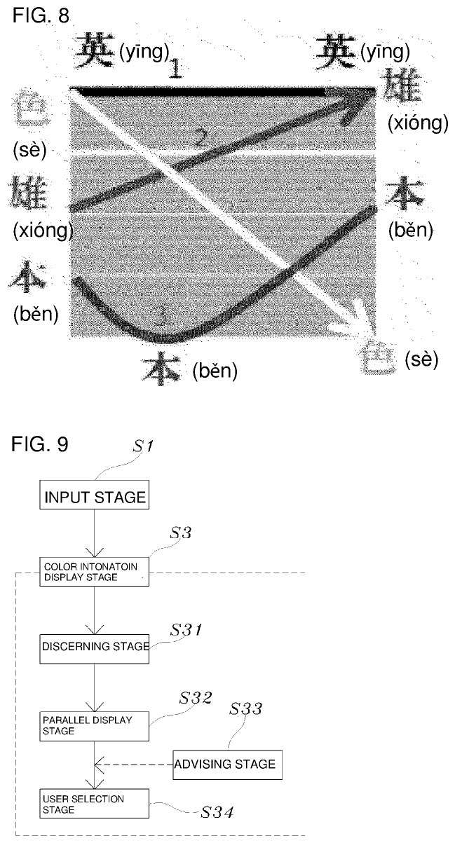

Referring to FIGS. 7 and 8, which show a Chinese sentence to which the color intonation display method of the present invention is applied, the intonation is displayed as a color intonation not as a special symbol per each Chinese character that constitute the sentence (word). By watching this, as explained above, a student may easily study intonation per Chinese character through the image associated with the color of the corresponding color intonation. That is, “young ( [symbol] )” displayed with black intonation is associated with continuous driving (constant speed driving) in a state where no traffic signal (light) is present, thereby facilitating recognition of the first intonation for which the tone is kept constant and application of the tone, “woong( [symbol] )” displayed with green intonation is associated with gradual acceleration according to turning on of the green signal, thereby facilitating recognition of the second intonation for which the tone rises constantly and application of the tone, “bon( [symbol] )” displayed with red is associated with sudden stop according to turning on of the red signal and starting again, thereby facilitating recognition of the third intonation for which the tone falls and then rises again and application of the tone, “saek( [symbol] )” displayed with yellow intonation is associated with gradual deceleration according to turning on of the yellow signal, thereby facilitating recognition of the second intonation for which the tone falls constantly and application of the tone, so that studying intonation per Chinese character becomes easy through the image associated with the color of the corresponding color intonation.

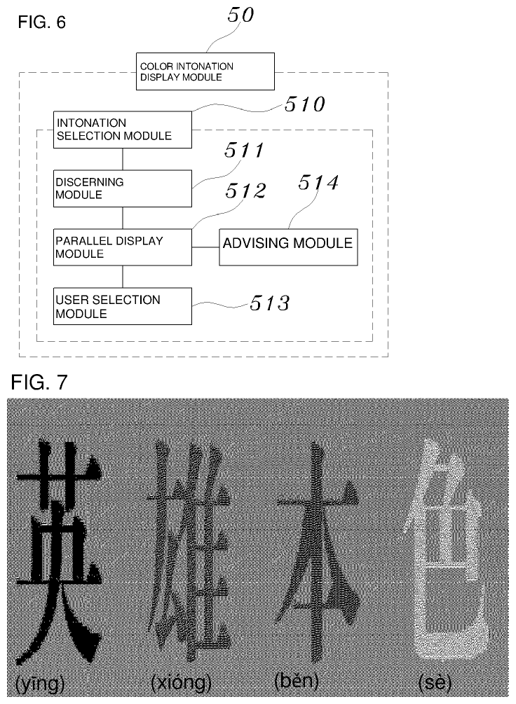

Referring to FIGS. 5 and 6, the color intonation display system according to an embodiment of the present invention comprises an input module (10) into which a Chinese character is input, an intonation storage (30) that stores intonation data for Chinese characters, and a color intonation display module (50) that matches intonation of the Chinese character input to said input module (10) with data stored in said intonation storage (30) and displays as the color intonation.

Said input module (10) is an element to which Chinese character is input. Diverse means for inputting Chinese characters to prepare documents or letters (for example, a keyboard in case of a computer, a keyboard with touch UI in case of a smart phone, a keyboard attached to a terminal in case of a PDA) may be used.

Said intonation storage (30) is an element that organizes intonation data for existing Chinese characters as database, and provides intonation database needed for a color intonation display module (50) explained below.

Said color intonation display module (50) is an element that matches the intonation of the Chinese character input to the data stored in said intonation storage (30) and displays it as a color intonation. A computing device, which can perform matching of Chinese character input with the database stored in the intonation storage (30), decision and control of color intonation display, may be used.

Especially, while said color intonation display module (50) is characterized in that it distinguishes the Chinese character input per word and matches it with data stored in the intonation storage and displays the color intonation, intonation for each Chinese character may be different kinds and when it is included in a word having a specific meaning, it will have one intonation corresponding to it, and therefore in order to display intonation for each Chinese character input, problems of inconvenience and time consumption of selecting appropriate intonation for every Chinese character having multiple intonations occur. Said color intonation display module (50) minimizes the stage in which an appropriate intonation must be selected among multiple intonations by displaying color intonations per word after distinguishing the Chinese character input per word, thereby reducing the time for color intonation (conversion) display time.

However, there are cases in which one Chinese character forms a single word. In this case, said color intonation display module (50) may further comprise an intonation selection module (510) that enables intonation selection when the Chinese character input is a single word having multiple intonations.

For this, in particular, said intonation selection module (510) may comprise a discerning module (511) that discerns whether the Chinese character input is a single word having multiple intonations, a parallel display module (512) that displays the multiple color intonations of the single word discerned and matched with data stored in said intonation storage (30) in parallel, a user selection module (513) in which one of the multiple intonations that are displayed in parallel may be selected by a user, and an advising module (514) that provides advice about the most appropriate intonation among the multiple intonations displayed in parallel considering correlation with words before or after the discerned single word.

Said discerning module (511) is an element that discerns whether the Chinese character input is a single word having multiple intonations, and it matches a single word consisting of one Chinese character to said intonation storage (30) to discern whether it is a single word having multiple intonations.

Said parallel display module (512) is an element that displays the multiple color intonations of the single word discerned by matching with data stored in said intonation storage (30) in parallel. It enables a user to select an appropriate intonation through the user selection module (513) explained below by displaying and presenting in parallel corresponding intonations of a single word having multiple intonations on a display screen.

Said user selection module (513) is an element that enables a user to select one among multiple intonations displayed in parallel. A user selects an appropriate intonation among the intonations listed in parallel via said parallel display module (512) with a touch UI or other means.

At this time, to improve the accuracy of user selection via said user selection module (513) additionally, said advising module (514) may provide advice about the most appropriate intonation among the multiple intonations displayed in parallel considering correlation with words before or after the discerned single word. That is, said advising module (514) matches the correlation with words that are located before or after the position of the single word, decides what meaning the corresponding single word has and which intonation needs to be applied accordingly, and suggests an advice (for example, among intonations displayed in parallel, the corresponding intonation is displayed differently.) thereby improving the accuracy of user selection.

A color intonation display method using said system is explained below referring to FIG. 9.

A color intonation display method according to an embodiment of the present invention comprises an input stage (S1) in which a Chinese character is input; and a color intonation display stage (S3) in which the Chinese character input is matched with intonation data stored in the intonation storage (30) and the color intonation is displayed.

Said input stage (S1) is a process in which Chinese character is input. Diverse means are used to input Chinese characters for preparing documents or letters.

Said color intonation display stage (S3) is a process that matches the Chinese character input with the intonation data stored in the intonation storage (30) and displays color intonation. The stage controls such that intonation of the Chinese character input is matched with the data stored in said intonation storage (30) and decided, and the decided intonation is displayed.

Especially, while said color intonation display stage (S3) is characterized in that it distinguishes the Chinese character input per word and matches it with data stored in the intonation storage (30) and displays the color intonation, intonation for each Chinese character may be different kinds and when it is included in a word having a specific meaning, it will have one intonation corresponding to it, and therefore in order to display intonation for each Chinese character input, problems of inconvenience and time consumption of selecting appropriate intonation for every Chinese character having multiple intonations occur. Said color intonation display stage (S3) minimizes the stage in which an appropriate intonation must be selected among multiple intonations by displaying color intonations per word after distinguishing the Chinese character input per word, thereby reducing the time for color intonation (conversion) display time.

However, there are cases in which one Chinese character forms a single word. In this case, said color intonation display stage (S3) enables intonation selection when the Chinese character input is a single word having multiple intonations. For this, said intonation selection stage (S3) may comprise a discerning stage (S31) that discerns whether the Chinese character input is a single word having multiple intonations, a parallel display stage (S32) that displays the multiple color intonations of the single word discerned and matched with data stored in said intonation storage (30) in parallel, an advising stage (S33) that provides advice about the most appropriate intonation among the multiple intonations displayed in parallel considering correlation with words before or after the discerned single word, and a user selection stage (S34) in which one of the multiple intonations that are displayed in parallel is selected by a user.

Said discerning stage (S31) is a process that discerns whether the Chinese character input is a single word having multiple intonations, and it matches a single word consisting of one Chinese character to said intonation storage (30) to discern whether it is a single word having multiple intonations.

Said parallel display module (S32) is a process that displays the multiple color intonations of the single word discerned by matching with data stored in said intonation storage (30) in parallel. It enables a user to select an appropriate intonation through the user selection process (S34) explained below by displaying and presenting in parallel corresponding intonations of a single word having multiple intonations on a display screen.

Said advising stage (S33) is a process that provides advice about the most appropriate intonation among the multiple intonations displayed in parallel considering correlation with words before or after the discerned single word. In order to improve accuracy of user selection in the user selection stage (S34) explained later, it matches the correlation with words that are located before or after the position of the single word, decides what meaning the corresponding single word has and which intonation needs to be applied accordingly, and suggests an advice (for example, among intonations displayed in parallel, the corresponding intonation is displayed differently.) thereby improving the accuracy of user selection.

Said user selection stage (S34) is a process in which a user selects one among multiple intonations displayed in parallel. A user selects an appropriate intonation among the intonations listed in parallel via said parallel display stage (S32) with a touch UI or other means thereby enabling color intonation display.

While the applicant explained preferred embodiments of the present invention, these embodiments are just exemplary embodiments that implement the technical idea of the present invention. Any change or modification are construed to belong to the scope of the present invention as far as the change or modification implement the technical idea of the present invention.

1. A color intonation display system characterized in that an intonation of Chinese character that is input to the system is changed to a color intonation and the color intonation is displayed.

2. The color intonation display system of claim 1 characterized in that said color intonation displays the first through the fourth intonations of Chinese character with different colors.

3. The color intonation display system of claim 2 characterized in that the system comprises an input module into which a Chinese character is input, an intonation storage that stores intonation data for Chinese characters, and a color intonation display module that matches intonation of the Chinese character input to said input module with data stored in said intonation storage module and displays as the color intonation.

4. The color intonation display system of claim 3 characterized in that said color intonation display module distinguishes the Chinese character input per word and matches it with data stored in the intonation storage and displays the color intonation.

5. The color intonation display system of claim 4 characterized in that said color intonation display module comprises an intonation selection module that enables intonation selection when the Chinese character input is a single word having multiple intonations.

6. The color intonation display system of claim 5 characterized in that said color intonation selection module comprises a discerning module that discerns whether the Chinese character input is a single word having multiple intonations, a parallel display module that displays the multiple color intonations of the single word discerned and matched with data stored in said intonation storage in parallel, and a user selection module in which one of the multiple intonations that are displayed in parallel may be selected by a user.

7. The color intonation display system of claim 6 characterized in that said intonation selection module further comprises an advising module that provides advice about the most appropriate intonation among the multiple intonations displayed in parallel considering correlation with words before or after the discerned single word.

8. The color intonation display system of claim 2 characterized in that said color intonation expresses the first intonation as black, the second intonation as green, the third intonation as red and the fourth intonation as yellow.

9. A color intonation display method characterized in that an intonation of Chinese character that is input to the system is displayed as a color intonation that changed the color of the Chinese character.

10. The color intonation display method of claim 9 characterized in that the method comprises an input stage in which a Chinese character is input; and a color intonation display stage in which the Chinese character input is matched with intonation data stored in an intonation storage and the color intonation is displayed.

11. The color intonation display method of claim 10 characterized in that said color intonation displays the first through the fourth intonations of Chinese character with different colors.

12. The color intonation display method of claim 11 characterized in that said color intonation display stage distinguishes the Chinese character input per word and matches it with data stored in the intonation storage and displays the color intonation.

13. The color intonation display method of claim 12 characterized in that said color intonation display stage comprises a discerning stage that discerns whether the Chinese character input is a single word having multiple intonations, a parallel display stage that displays the multiple color intonations of the single word discerned and matched with data stored in said intonation storage in parallel, and a user selection stage in which one of the multiple intonations that are displayed in parallel is selected by a user.

14. The color intonation display method of claim 13 characterized in that said color intonation display stage further comprises an advising stage that provides advice about the most appropriate intonation among the multiple intonations displayed in parallel considering correlation with words before or after the discerned single word.

15. A computer-readable recording medium characterized in that a program to perform the method of claim 9 is recorded in the medium.
